(19) United States
(12) Patent Application Publication
(10) Pub. No.: US 2012/0163752 A1
(43) Pub. Date: Jun. 28, 2012

(54) Method for manufacturing printed circuit board with optical waveguides

(75) Inventors: Sanghoon Kim, Gunpo-si (KR); Joonsung Kim, Suwon-si (KR); Hanseo Cho, Seoul (KR)

(73) Assignee: SAMSUNG ELECTRO-MECHANICS CO., LTD., Suwon-si (KR)

(21) Appl. No.: 13/067,556

(22) Filed: Jun. 8, 2011

(30) Foreign Application Priority Data
Dec. 22, 2010 (KR) 10-2010-0132165

(51) Int. Cl. G02B 6/12; B05D 5/12

(52) U.S. Cl. 385/14; 427/97.6

(57) ABSTRACT

Disclosed herein is a method for manufacturing a printed circuit board with optical waveguides capable of reducing light loss by forming a bent portion having a changing pattern shape on a core layer and attaching a reflective member thereto to increase reflectivity. The method for manufacturing a printed circuit board with optical waveguides includes; (a) forming a lower clad layer on a base substrate; (b) applying a core material onto the lower clad layer; (c) performing exposure on the core material using a photo mask having a pattern; (d) performing development on the core material subjected to the exposure and forming a bent portion having a changing pattern shape to form a core layer; (e) applying an upper clad layer onto the lower clad layer having the core layer formed thereon; (f) performing exposure and development on the upper clad layer to expose a reflective portion of the machined bent portion to the outside; and (g) attaching a reflective member to the reflective portion exposed to the outside. Therefore, the bent portion having the changing pattern shape is machined to have a curved shape or an oblique shape and the reflective member is attached thereto, thereby making it possible to minimize light loss.

### CROSS REFERENCE(S) TO RELATED APPLICATIONS

This application claims the benefit under 35 U.S.C. Section 119 of Korean Patent Application Serial No. 10-2010-0132165, entitled “Method For Manufacturing Printed Circuit Board With Optical Waveguides” filed on Dec. 22, 2010, which is hereby incorporated by reference in its entirety into this application.

### BACKGROUND OF THE INVENTION

1. Technical Field

The present invention relates to a method for manufacturing a printed circuit board with optical waveguides, and more particularly, to a method for manufacturing a printed circuit board with optical waveguides capable of reducing light loss by forming a bent portion having a changing pattern shape on a core layer and attaching a reflective member thereto to increase reflectivity.

2. Description of the Related Art

In an electronic component, a printed circuit board technology using a copper based electric layer according to the related art has reached its limitation due to the recent trend of high speed and large capacity data. That is, there is a limitation in a large capacity high speed data transmission due to effects such as a limitation in a transmission speed (2.5 Gbps or less), crosstalk characteristics between electrical lines, a limitation in mounting density, an electromagnetic interference (EMI), and the like. Therefore, printed circuit boards including an optical layer have been spotlighted as a technology capable of overcoming problems of the copper based electric layer according to the related art.

Among them, research into a printed circuit board with optical waveguides having a hybrid structure in which optical fibers and optical waveguides are embedded in the printed circuit board to configure an optical layer and an electric layer as a multilayer has been actively conducted. FIG. 1 is a cross-sectional view showing the printed circuit board with optical waveguides.

Generally, the optical layer is made of a polymer material having high transparency, and is configured of a core layer having an optical signal actually transmitted thereto and having a rectangular cross section and a clad layer surrounding the core layer and having a lower reflective index than that of the core layer. As a method of forming a core pattern of the optical waveguide, there are methods such as an exposure/development method, an exposure/reflective index change method, a laser machining method, and the like. Among them, the exposure/development method has been mainly used because it has advantages in that it may form various pattern shapes, has less limitation in the characteristics of a material used for the optical waveguide, and has high productivity.

FIG. 2 is a cross sectional view showing a printed circuit board with optical waveguides according to a sequence of forming core patterns using an exposure/development method.

First, a lower clad layer is formed on a base substrate, and a core material is applied thereto. Exposure is performed by irradiating the core material with an ultraviolet ray using a photo mask having a predetermined pattern, and a non-exposed region is then removed by being dissolved in a developer (for example, acetone) to form a core layer. Finally, an upper clad layer is formed on the lower clad layer having the core layer formed thereon to complete the printed circuit board with optical waveguides.

The exposure/development method has used the photo mask during exposure as described above. However, a bent portion in which a pattern direction is changed is formed to have a shape such as a circular arc to generate a grain pattern according to quality of a pattern outer portion of the mask, thereby causing increase in light loss. In addition, the quality of the pattern outer portion in an oblique direction is particularly degraded due to characteristics of a process for manufacturing the photo mask, and a radius of curvature is limited according to a numerical aperture determined by a core of the optical waveguide and a reflective index of a clad material.

### SUMMARY OF THE INVENTION

An object of the present invention is to provide a method for manufacturing a printed circuit board with optical waveguides capable of reducing light loss by forming a bent portion having a changing pattern shape and attaching a reflective member thereto in forming a core pattern of an optical waveguide to improve quality of a pattern outer portion and increase reflectivity.

According to an exemplary embodiment of the present invention, there is provided a method for manufacturing a printed circuit board with optical waveguides, the method including: (a) forming a lower clad layer on a base substrate; (b) applying a core material onto the lower clad layer; (c) performing exposure on the core material using a photo mask having a pattern; (d) performing development on the core material subjected to the exposure and forming a bent portion having a changing pattern shape to form a core layer; (e) applying an upper clad layer onto the lower clad layer having the core layer formed thereon; (f) performing exposure and development on the upper clad layer to expose a reflective portion of the machined bent portion to the outside; and (g) attaching a reflective member to the reflective portion exposed to the outside.

The forming of the bent portion having the changing pattern shape may include forming the bent portion to have a curved shape or forming the bent portion to have an oblique shape.

At the attaching of the reflective member to the reflective portion, the reflective member may include a metal member.

The attaching of the reflective member may be performed using a sputtering scheme, and may include coating one selected from a group consisting of nickel, copper, gold, titanium or a mixture thereof.

The method may further include stacking an insulating layer on a surface of the upper clad layer.

According to another exemplary embodiment of the present invention, there is provided a method for manufacturing a printed circuit board with optical waveguides, the method including: (a) forming a lower clad layer on a base substrate; (b) applying a core material onto the lower clad layer; (c) performing exposure on the core material using a photo mask having a pattern; (d) performing development on the core material subjected to the exposure and forming a bent portion having a changing pattern shape to form a core layer; (e) attaching a reflective member to a reflective portion of the bent portion; and (f) applying an upper clad layer onto the lower clad layer having the core layer formed thereon.

The machining of the bent portion having the changing pattern shape may include forming the bent portion to have a curved shape or forming the bent portion to have an oblique shape.

The reflective member may include a metal member.

The attaching of the reflective member may be performed using a sputtering scheme, and may include coating one selected from a group consisting of nickel, copper, gold, titanium or a mixture thereof.

The method may further include stacking an insulating layer on a surface of the upper clad layer.

According to another exemplary embodiment of the present invention, there is provided a printed circuit board with optical waveguides, the printed circuit board including: a lower clad layer formed on a base substrate; a core layer formed on the lower clad layer and having a bent portion machined thereon, the bent portion having a changing pattern shape; and an upper clad layer applied onto the lower clad layer having the core layer formed thereon, wherein a reflective portion of the machined bent portion having the changing pattern shape is exposed to the outside and a reflective member is attached to the reflective portion.

### BRIEF DESCRIPTION OF THE DRAWINGS

FIG. 1 is a cross-sectional view showing a printed circuit board with optical waveguides;

FIG. 2 is a cross sectional view showing a printed circuit board with optical waveguides according to a sequence of forming core patterns using an exposure/development method;

FIG. 3 is a flowchart showing a method for manufacturing a printed circuit board with optical waveguides according to an exemplary embodiment of the present invention;

FIG. 4 is a top plan view showing a process of forming a bent portion having a changing core pattern and attaching a reflective member thereto;

FIG. 5 is a cross-sectional view showing an example of stacking an insulating layer on a surface of an upper clad layer;

FIGS. 6A to 6C are views showing a method for manufacturing a printed circuit board with optical waveguides according to an exemplary embodiment of the present invention;

FIGS. 7A to 7C are views showing a method for manufacturing a printed circuit board with optical waveguides according to an exemplary embodiment of the present invention;

FIG. 8 is a flowchart showing a method for manufacturing a printed circuit board with optical waveguides according to another exemplary embodiment of the present invention;

FIG. 9A is a top plan view showing a printed circuit board according to an exemplary embodiment of the present invention, and FIG. 9B is a cross-sectional view taken along the line A-A′ of FIG. 9A; and

FIG. 10A is a top plan view showing a printed circuit board according to an exemplary embodiment of the present invention, and FIG. 10B is a cross-sectional view taken along the line B-B′ of FIG. 10A.

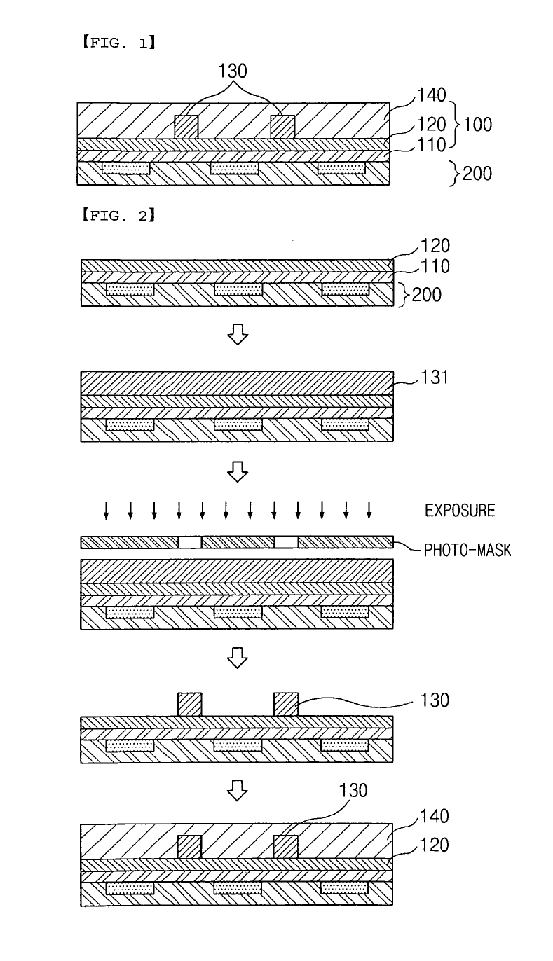

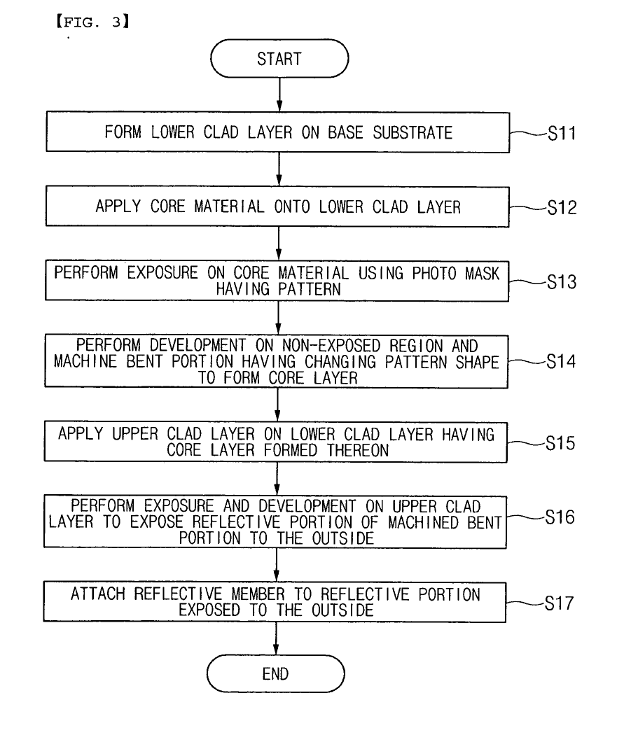

### DESCRIPTION OF THE PREFERRED EMBODIMENTS

Hereinafter, exemplary embodiments of the present invention will be described in detail with reference to the accompanying drawings. The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

The present invention relates to a method for manufacturing a printed circuit board with optical waveguides, and more particularly, to a method for manufacturing a printed circuit board with optical waveguides capable of reducing light loss by forming a bent portion having a changing pattern shape on a core layer and attaching a reflective member thereto to increase reflectivity. Therefore, the present invention does not relate to a structure, a process, and the like of an electric layer.

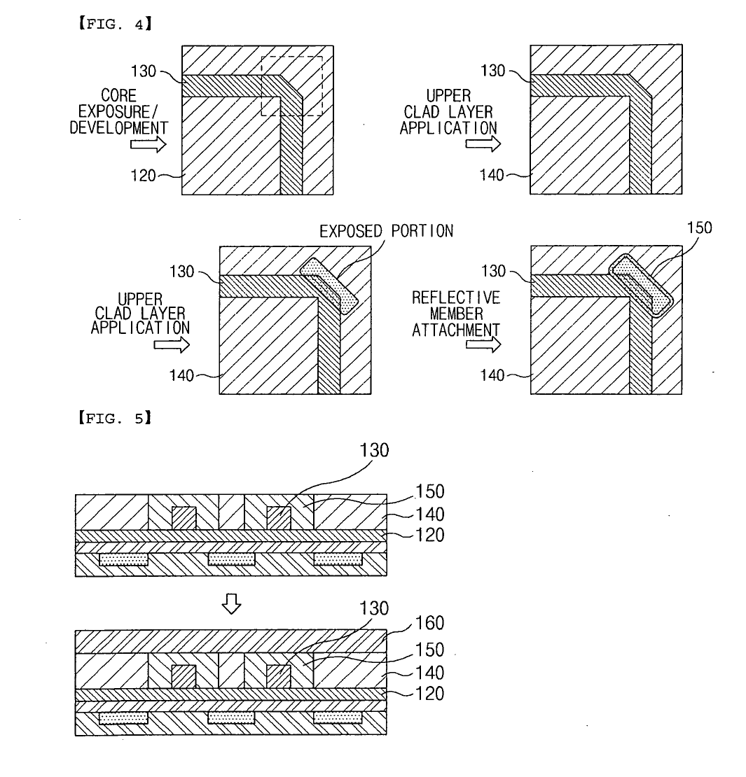

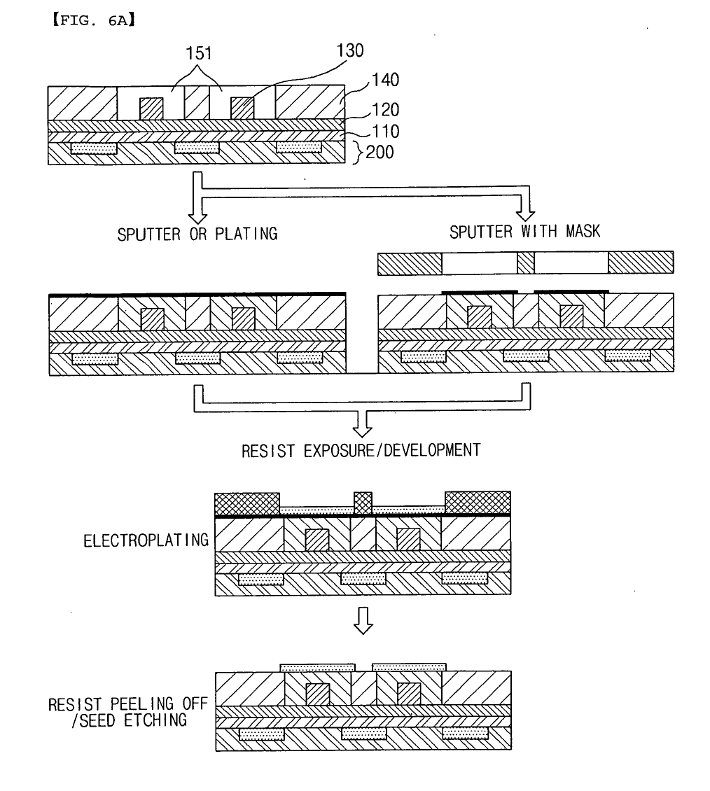

First, FIG. 3 is a flowchart showing a method for manufacturing a printed circuit board with optical waveguides according to an exemplary embodiment of the present invention; and FIG. 4 is a top plan view showing a process of forming a bent portion having a changing core pattern and attaching a reflective member thereto, which is an example of a process for manufacturing a printed circuit board according to the above-mentioned method. A process of a method (hereinafter, referred to as a ‘method 1’) for manufacturing a printed circuit board will be described with reference to FIGS. 3 and 4.

First, a lower clad layer is formed on a base substrate S11, a core material is applied onto the lower clad layer S12, and exposure is performed on the core material by irradiating the core material with an ultraviolet ray using a photo mask having a pattern S13. After the exposure is performed, development is performed on a non-exposed region. That is, the non-exposed region is removed by being dissolved in a developer (for example, acetone) and a bent portion having a changing pattern shape is machined to form a core layer S14.

However, although FIG. 3 shows a case in which the non-exposed region is developed, a portion that receives light may respond to the light or a portion that does not the light may respond to the light when the exposure is performed, such that the non-exposed region may be developed or the exposed region may be developed. However, the present invention will describe a case in which the portion receiving the light responds to the light such that the non-exposed region is developed by way of example.

In addition, the bent portion may be machined to have a curved shape or an oblique shape. The core layer is exposed to the outside through the above-mentioned machining process. A portion of the core layer exposed to the outside will be referred to as a reflective portion below.

As shown in FIG. 4, when the bent portion having the changing pattern is a portion bent at 90 degrees, the bent portion is configured to be bent at 45 degrees, such that it has an oblique shape, thereby making it possible to directly reflect an optical signal moving along the core pattern. When the bent portion is machined to have the oblique shape as described above, an area of the bent portion is significantly reduced, as compared to a curve shaped bent portion, such that bending at 90 degrees may be allowed even in a narrow region, thereby making it possible to design a high density optical waveguide pattern. In addition, the bent portion is not affected by the numerical aperture between the core layer and the clad layer, such that there is no limitation in implementing material characteristics.

Further, a shape of the bent portion having the changing core pattern is machined, while the core layer is formed, thereby not causing a problem in matching characteristics.

Next, an upper clad layer is applied onto the lower clad layer having the core layer formed thereon S15, and exposure and development are performed on the upper clad layer to expose a reflective portion of the machined bent portion to the outside S16. A reflective member is attached to the reflective portion exposed to the outside S17.

The reflective member may include a metal member, and may be attached to the reflective portion by a sputtering method. The reflective member may be attached to the reflective portion by coating one selected from a group consisting of nickel, copper, gold, titanium or a mixture thereof thereto. In this case, the reflective member may be preferably coated so that the reflective portion has transmissivity of 0%, and may be made of a metal having high reflectivity, in addition to nickel, copper, gold, titanium.

When particles having high energy impact a solid surface, atoms and molecules on the solid surface exchange momentum with the particles having high energy to be ejected from the solid surface to the outside. This phenomenon is called sputtering. The reflective member in a film form is attached to a surface of an object using the sputtering. That is, when ionized atoms (Ar) are accelerated by an electric field to impact a source material, atoms in the source material are ejected due to the impact. Then, the ejected atoms are attached to a desired surface.

Based on this principle, the metal member is coated, while forming a film on the reflective portion, which is the exposed portion, as shown in FIG. 4. As such, the metal particles are coated by the sputtering scheme, thereby making it possible to increase the reflectivity of the reflective portion and prevent contamination of the reflective portion.

Although not shown in FIG. 3, the method for manufacturing a printed circuit board with optical waveguides according to an exemplary embodiment of the present invention may further include stacking an insulating layer on a surface of the upper clad layer. FIG. 5 is a cross-sectional view showing an example of stacking an insulating layer 160 on a surface of an upper clad layer 140. The insulating layer 160 may be made of any kind of material having insulating property. The insulating material is stacked on the upper clad layer 140, thereby making it possible to protect a groove shape or the reflective member from external shock, contamination, thermal deformation, or the like.

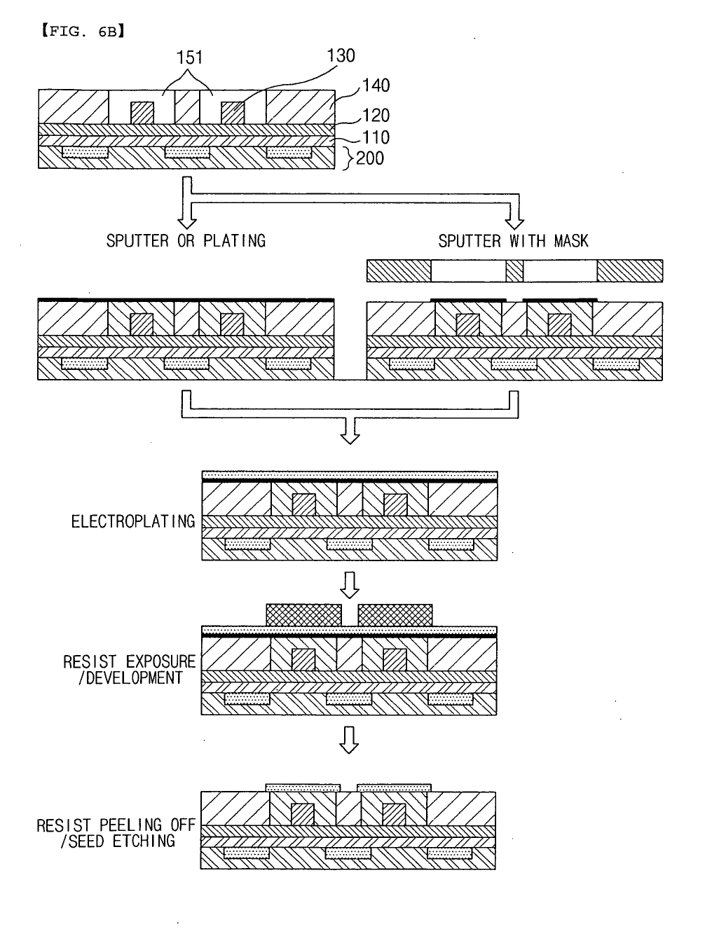

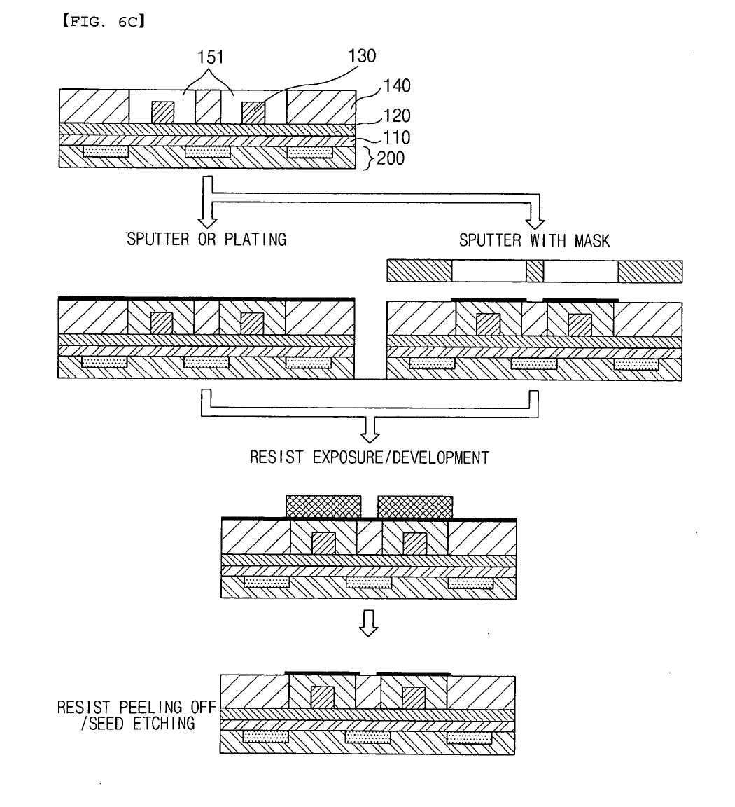

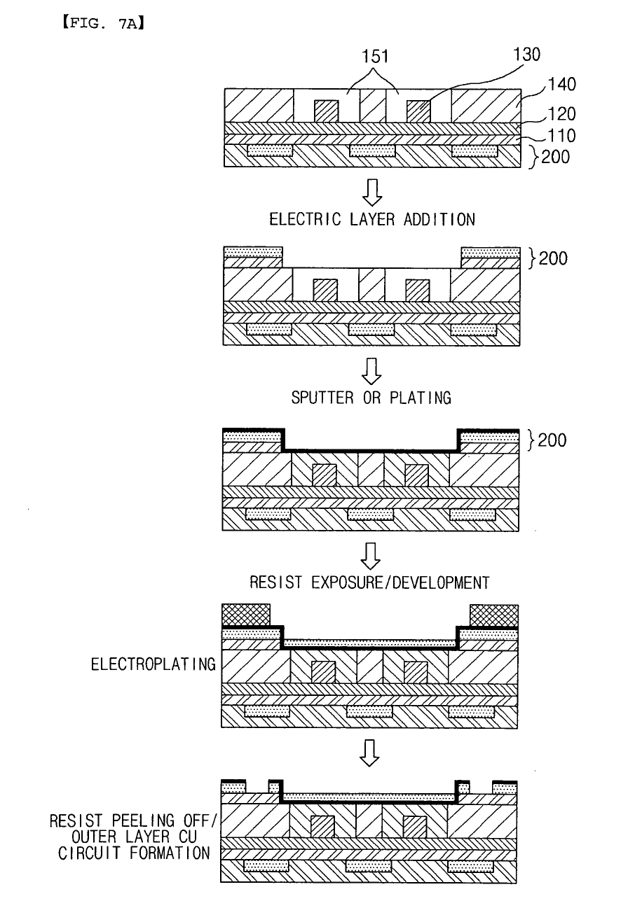

FIGS. 6A to 6C are views showing a method (method 1) for manufacturing a printed circuit board with optical waveguides according to an exemplary embodiment of the present invention. Particularly, FIGS. 6A to 6C, respectively, show an example of a method of attaching the reflective member as a thin layer and an example of a method of attaching the reflective member in a mask type, using the sputtering scheme. After the reflective member is attached, a process of exposing and developing a resist, performing electroplating, peeling off the resist, and then etching a seed may be performed, as shown in FIG. 6A, or a process of performing the electroplating, exposing and developing the resist, etching the seed, and then peeling off the resist may be performed, as shown in FIG. 6B. In addition, a process of exposing and developing the resist, etching the seed, and then peeling off the resist without performing the electroplating may also be performed, as shown in FIG. 6C.

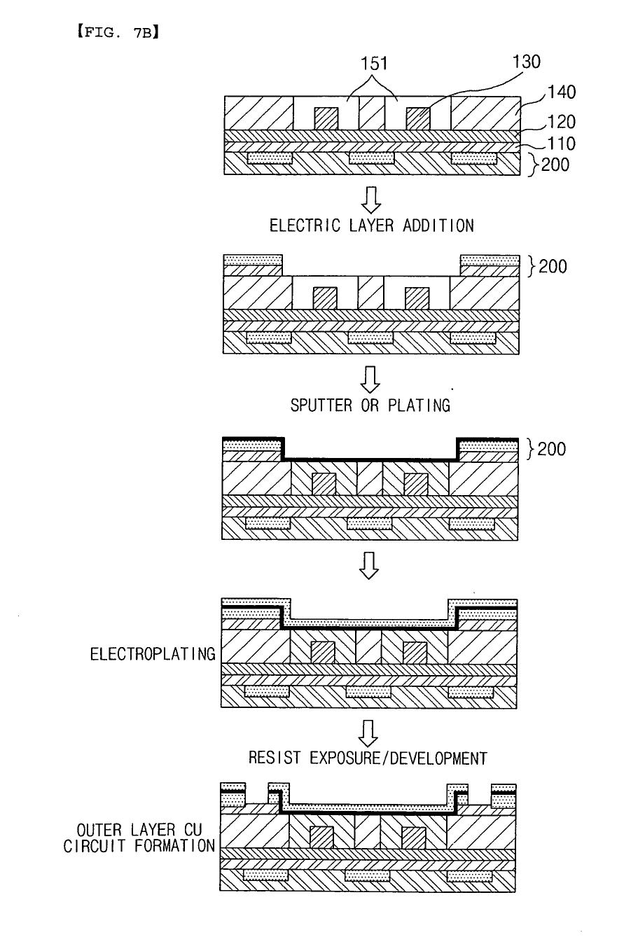

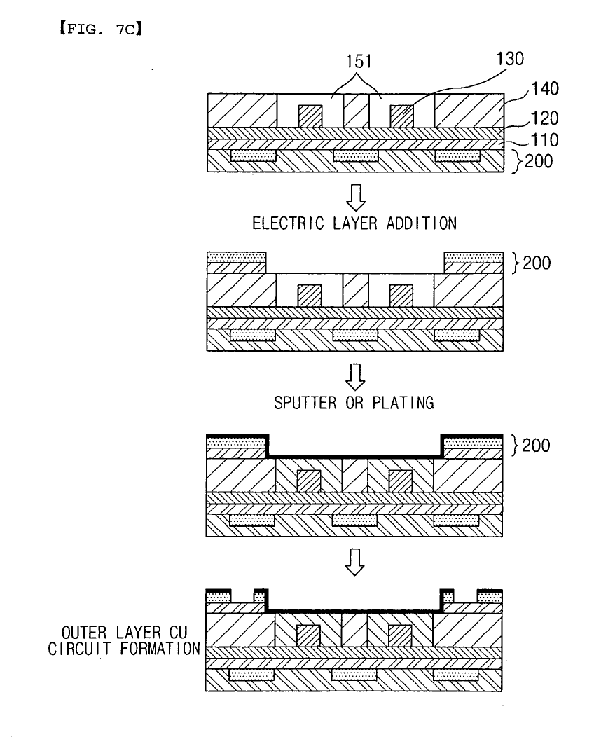

FIGS. 7A to 7C are views showing a method (method 1) for manufacturing a printed circuit board with optical waveguides according to another exemplary embodiment of the present invention. The present invention, which relates to a method for manufacturing a printed circuit board, does not relate to a structure, a process, and the like of an electric layer; however, FIGS. 7A to 7C, respectively, show examples in which the reflective portion is exposed, the electric layer is formed, and the reflective member is then attached thereto. As described above, the upper clad layer is developed, the reflective portion is exposed, the electric layer is added, and the reflective member is then attached thereto using the sputtering scheme. The reflective member may be attached as the thin layer or may be attached in the mask type; however, FIGS. 7A to 7C shows examples in which the reflective member is attached as the thin layer.

After the reflective member is attached, a process of exposing and developing the resist, performing the electroplating, peeling off the resist, and then forming an outer layer Cu circuit may be performed, as shown in FIG. 7A, or a process of performing the electroplating, exposing and developing the resist, and then forming the outer layer Cu circuit may be performed, as shown in FIG. 7B. In addition, a process of exposing and developing the resist, etching the seed, and peeling off the resist, and then forming the outer layer Cu circuit may also be performed, as shown in FIG. 7C; however, a process of exposing and developing the resist, etching the seed, and then peeling off the resist is not separately shown in FIG. 7C.

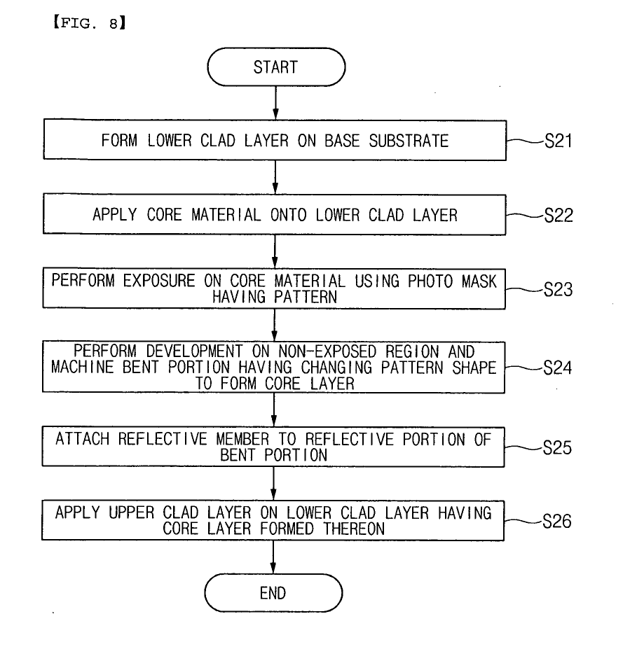

FIG. 8 is a flowchart showing a method for manufacturing a printed circuit board with optical waveguides according to another exemplary embodiment of the present invention. A method (hereinafter, referred to as a ‘method 2’) for manufacturing a printed circuit board with optical waveguides according to another exemplary embodiment of the present invention will be described with reference to FIG. 8.

First, a lower clad layer is formed on a base substrate (S21), and a core material is applied onto the lower clad layer (S22). Exposure is performed on the core material by irradiating the core material with an ultraviolet ray using a photo mask having a pattern (S23), and development is performed on a non-exposed region and a bent portion having a changing pattern shape is machined to form a core layer (S24). In this case, the bent portion may be machined to have a curved shape or an oblique shape, which is the same as the above-mentioned method for manufacturing a printed circuit board with optical waveguides. That is, the bent portion may have a curved shape or an oblique shape.

Next, a reflective member is attached to a reflective portion of the bent portion (S25), and an upper clad layer is applied onto the lower clad layer having the core layer formed thereon (S26).

While the exposure and the development are performed on the upper clad layer and the reflective member is then attached thereto in the method 1, the reflective member is attached to the reflective portion, the upper clad layer is applied onto the lower clad layer, and the reflective member is then exposed to the outside in the method 2.

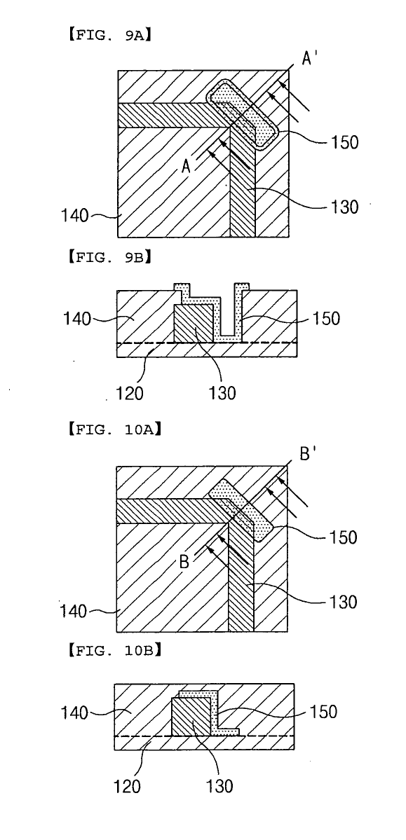

In order to indicate a difference between the method 1 and the method 2, FIG. 9A shows a top plan view of a printed circuit board according to the method 1 and FIG. 9B shows a cross-sectional view taken along the line A-A′ of FIG. 9A, and FIG. 10A shows a top plan view of a printed circuit board according to the method 2, and FIG. 10B shows a cross-sectional view taken along the line B-B′ of FIG. 10A.

The upper clad layer is formed and the reflective member is then attached to the reflective member in the method 1, such that the reflective member may be formed up to an inside of a bent pattern, as shown in FIG. 9B. However, the reflective member is attached to the reflective portion and the upper clad layer is formed in the method 2, such that the reflective member is not formed inside of the bent pattern. In spite of this difference between the method 1 and the method 2, both of the method 1 and the method 2 may generate the same effect in that they may reduce light loss by using the reflective member.

Meanwhile, although not shown in FIG. 8, the method (method 2) for manufacturing a printed circuit board with optical waveguides according to another exemplary embodiment of the present invention may further include stacking an insulating layer on a surface of the upper clad layer. This is the same as in the method 1.

Meanwhile, the printed circuit board with optical waveguides according to an exemplary embodiment of the present is configured to include the lower clad layer formed on the base substrate, the core layer formed on the lower clad layer and having the bent portion machined thereon, the bent portion having the changing pattern shape, and the upper clad layer applied onto the lower clad layer having the core layer formed thereon, wherein the reflective portion of the machined bent portion having the changing pattern shape is exposed to the outside and the reflective member is attached to the reflective portion.

In addition, according to the exemplary embodiments of the present invention, the printed circuit board with optical waveguides manufactured by using the method 1 and the method 2 may be provided.

The method for manufacturing a printed circuit board with optical waveguides according to the exemplary embodiments of the present invention provides effects as described below.

First, the bent portion having the changing pattern shape is machined to have a curved shape or an oblique shape and the reflective member is attached thereto, thereby making it possible to minimize light loss.

Second, the bent portion having the changing pattern shape is not affected by the numerical aperture between the core layer and the clad layer, such that there is no limitation in implementing material characteristics.

Third, the bent portion having the changing pattern shape, particularly, a portion bent at 90 degrees may be bent at 90 degrees in a narrow region than that of a round shaped pattern according to the related art, thereby making it possible to design a high density optical waveguide pattern.

Fourth, the bent portion having the changing pattern shape is machined, while a corner layer pattern is formed, thereby not causing a problem in matching characteristics and simplifying a process.

Although the present invention has been described with reference to exemplary embodiments and the accompanying drawings, it would be appreciated by those skilled in the art that the present invention is not limited thereto but various modifications and alterations might be made without departing from the scope defined in the claims and their equivalents.

What is claimed is:

1. A method for manufacturing a printed circuit board with optical waveguides, the method comprising:
(a) forming a lower clad layer on a base substrate;
(b) applying a core material onto the lower clad layer;
(c) performing exposure on the core material using a photo mask having a pattern;
(d) performing development on the core material subjected to the exposure and forming a bent portion having a changing pattern shape to form a core layer;
(e) applying an upper clad layer onto the lower clad layer having the core layer formed thereon;
(f) performing exposure and development on the upper clad layer to expose a reflective portion of the machined bent portion to the outside; and
(g) attaching a reflective member to the reflective portion exposed to the outside.

2. The method according to claim 1, wherein the forming of the bent portion having the changing pattern shape includes forming the bent portion to have a curved shape.

3. The method according to claim 1, wherein the forming of the bent portion having the changing pattern shape includes forming the bent portion to have an oblique shape.

4. The method according to claim 1, wherein at the attaching of the reflective member to the reflective portion, the reflective member includes a metal member.

5. The method according to claim 4, wherein the attaching of the reflective member is performed using a sputtering scheme, and includes coating one selected from a group consisting of nickel, copper, gold, titanium or a mixture thereof.

6. The method according to claim 1, further comprising stacking an insulating layer on a surface of the upper clad layer.

7. A method for manufacturing a printed circuit board with optical waveguides, the method comprising:
(a) forming a lower clad layer on a base substrate;
(b) applying a core material onto the lower clad layer;
(c) performing exposure on the core material using a photo mask having a pattern;
(d) performing development on the core material subjected to the exposure and forming a bent portion having a changing pattern shape to form a core layer;
(e) attaching a reflective member to a reflective portion of the bent portion; and
(f) applying an upper clad layer onto the lower clad layer having the core layer formed thereon.

8. The method according to claim 7, wherein the forming of the bent portion having the changing pattern shape includes forming the bent portion to have a curved shape.

9. The method according to claim 7, wherein the forming of the bent portion having the changing pattern shape includes forming the bent portion to have an oblique shape.

10. The method according to claim 7, wherein the reflective member includes a metal member.

11. The method according to claim 10, wherein the attaching of the reflective member is performed using a sputtering scheme, and includes coating one selected from a group consisting of nickel, copper, gold, titanium or a mixture thereof.

12. The method according to claim 7, further comprising stacking an insulating layer on a surface of the upper clad layer.

13. A printed circuit board with optical waveguides, the printed circuit board comprising:
a lower clad layer formed on a base substrate;
a core layer formed on the lower clad layer and having a bent portion machined thereon, the bent portion having a changing pattern shape; and
an upper clad layer applied onto the lower clad layer having the core layer formed thereon,
wherein a reflective portion of the machined bent portion having the changing pattern shape is exposed to the outside and a reflective member is attached to the reflective portion.
